(19) United States
(12) Patent Application Publication
(10) Pub. No.: US 2015/0224656 A1
(43) Pub. Date: Aug. 13, 2015

(54) HAIR TRIMMER WITH VACUUM COLLECTION SYSTEM

(71) Applicant: Spectrum Brands, Inc., Middleton, WI (US)

(72) Inventors: Andrew David Johnson, Middleton, WI (US); Jim Varney, Acton, MA (US); Bryan Hotaling, Acton, MA (US); John MacNeill, Acton, MA (US); Matt Naples, Acton, MA (US); Pat Devine, Acton, MA (US)

(21) Appl. No.: 14/621,888

(22) Filed: Feb. 13, 2015

Related U.S. Application Data
(60) Provisional application No. 61/939,505, filed on Feb. 13, 2014.

(51) Int. Cl. B26B 19/44; B26B 19/38; B26B 19/28; B26B 19/02

(52) U.S. Cl. CPC B26B 19/44; B26B 19/02; B26B 19/382; B26B 19/28

(57) ABSTRACT

An electric hand-held apparatus for trimming hair includes a housing having an inlet at the upstream end for receiving air and hair clippings into an airway that extends within the housing to an exhaust. The apparatus also includes a vacuum source and a cutting assembly. Additionally, the apparatus includes a motor having a motor output shaft rotatable about a motor axis. The motor axis is parallel to and transversely offset from a vacuum-source axis of rotation. The at least one reciprocating blade is driven by the motor at a first speed. The vacuum source is driven by the motor at a second speed greater than the first speed.

### CROSS REFERENCE TO RELATED APPLICATIONS

This patent application relates to and claims priority to U.S. provisional patent application Ser. No. 61/939,505 filed Feb. 13, 2014, which is hereby incorporated by reference in its entirety.

### BACKGROUND

This invention relates generally to an apparatus for trimming hair, and more particularly to a hand-held hair trimming apparatus having a self-contained vacuum system for collecting hair clippings during use.

Hand-held hair clippers and trimmers have been used to cut hair in barber shops and private homes for many years. For example, hair clippers are commonly used to cut the hair on one's head and to cut animal hair. In addition, trimmers may be used to trim moustaches and beards, hair around nasal passages and ears, and hair on various other desired body locations. Such hair clippers and trimmers typically comprise a housing sized and shaped to be held comfortably in one hand, and a cutting assembly mounted at one end of the housing. The cutting assembly commonly comprises a stationary toothed blade and a reciprocating toothed blade slidably mounted adjacent the stationary blade and driven back and forth by a motor enclosed in the housing. A comb may be mounted on the end of the housing to guide hair into the cutting assembly and to generally control the length of the cut.

The hair clippings produced by many conventional hair trimmers simply fall away from the apparatus onto the person or animal whose hair is being trimmed or are otherwise scattered about the work area. To this end, other hair clippers have been designed to operate in conjunction with an internal or external vacuum system for collecting the hair clippings as the hair cutting is performed. This can reduce the amount of cleaning needed after the cut is finished. An example of an internal vacuum system, U.S. Pat. No. 7,114,257, discloses a motor with a rotary shaft that drives a foil cutter. A propeller is disposed on the rotary shaft at approximately the axial midpoint of the housing. The propeller rotates to draw in air and hair clippings through the cutter end of the housing. The hair clippings are collected in a collection bin within the housing, while the air is expelled through vents in the end of the housing opposite the cutter. A similar vacuum arrangement is disclosed in U.S. Pat. No. 3,905,099 for a rotating drum cutter with a reciprocating edge trimmer. Such systems have been limited, however, because the motor speed must be chosen to operate the cutting means efficiently and safely, limiting the vacuum strength that can be created by a fan driven by the same motor, and the internal air flow path must twist around various internal components, which causes a corresponding loss in vacuum strength. As a result, an undesirably large portion of the clipped hairs may not be captured by the vacuum system.

One improvement on the vacuum system is to use one motor for the cutting means and a second, higher-speed motor for the vacuum arrangement. However, this arrangement necessitates a larger housing for the apparatus to accommodate two motors. It also increases a cost of manufacture of the apparatus.

Another potential improvement on the vacuum system is disclosed in U.S. Pat. No. 2,933,809. A single motor with an axis of rotation lying generally along the axial centerline of the casing drives a quill shaft coupled to an internal fan to create suction. A system of four gears steps down the rotational speed of the motor to drive a rotating cutter via a drive shaft nested within, and coaxial with, the quill shaft. While this system creates separate speeds for the suction fan and the cutting means, the necessarily complex multi-element gearing and nested shaft arrangement increases a cost of manufacture of the apparatus and a size of the casing, and makes the apparatus more susceptible to mechanical failure.

There is a need, therefore, for an improved hair trimmer capable of clipping hairs and of providing a more suitable vacuum strength for the capture and collection of hairs, without the added size and expense of a second motor or a complex gear system.

### SUMMARY

In one embodiment, an electric hand-held apparatus for trimming hair is provided. The apparatus includes a housing having an upstream end, a downstream end, an inlet at the upstream end for receiving air and hair clippings into the housing, an exhaust downstream of the inlet for exhausting air from the housing, and an airway extending within the housing from the inlet to the exhaust for directing air flow through the housing. The apparatus also includes a vacuum source disposed in the airway intermediate the inlet and the exhaust. The vacuum source is rotatable about an axis of rotation of the vacuum source to draw air into the housing through the inlet and along the airway for subsequent exhaustion from the housing through the exhaust. The apparatus further includes a cutting assembly having at least one reciprocating blade. The cutting assembly is disposed exterior of the airway in proximity to the housing inlet such that hair clippings produced upon operation of the cutting assembly are drawn through the housing inlet into the airway for flow toward the vacuum source. Additionally, the apparatus includes a motor disposed within the housing, the motor having a motor output shaft rotatable about a motor axis. The motor axis is parallel to and transversely offset from the vacuum-source axis of rotation. The at least one reciprocating blade is operatively connected to the motor output shaft for driving movement of the at least one reciprocating blade by the motor at a first speed. The vacuum source is operatively connected to the motor output shaft for driving movement of the vacuum source by the motor at a second speed greater than the first speed at which the at least one reciprocating blade is driven.

In another embodiment, electric hand-held apparatus for trimming hair is provided. The apparatus includes a housing having an upstream end, a downstream end, an inlet at the upstream end for receiving air and hair clippings into the housing, an exhaust downstream of the inlet for exhausting air from the housing, and an airway extending within the housing from the inlet to the exhaust for directing air flow through the housing. The apparatus also includes a vacuum fan disposed in the airway intermediate the inlet and the exhaust. The vacuum fan is operable to draw air into the housing through the inlet and along the airway for subsequent exhaustion from the housing through the exhaust. The vacuum fan has an inlet generally centered on an axis of rotation of the vacuum fan, and a portion of the airway upstream of the vacuum fan is configured to facilitate the flow of air into the vacuum fan inlet in a flow direction substantially parallel to the fan axis of rotation. The apparatus further includes a cutting assembly having at least one reciprocating blade. The cutting assembly is disposed exterior of the airway in proximity to the housing inlet such that hair clippings produced upon operation of the cutting assembly are drawn through the housing inlet into the airway for flow toward the vacuum source. Additionally, the apparatus includes a motor disposed within the housing, the motor having a motor output shaft rotatable about a motor axis. The motor axis is parallel to and transversely offset from the fan axis of rotation. The at least one reciprocating blade is operably connected to the motor output shaft for driving movement of the at least one reciprocating blade by the motor at a first speed. The vacuum fan is operatively connected to the motor output shaft for driving rotation of the vacuum fan by the motor at a second speed greater than the first speed at which the at least one reciprocating blade is driven.

In yet another embodiment, an electric hand-held apparatus for trimming hair is provided. The apparatus includes a housing having an upstream end, a downstream end, an inlet at the upstream end for receiving air and hair clippings into the housing, an exhaust downstream of the inlet for exhausting air from the housing, and an airway extending within the housing from the inlet to the exhaust for directing air flow through the housing. The apparatus also includes a vacuum source disposed in the airway intermediate the inlet and the exhaust. The vacuum source is rotatable about an axis of rotation of the vacuum source to draw air into the housing through the inlet and along the airway for subsequent exhaustion from the housing through the exhaust. The apparatus further includes a cutting assembly including at least one reciprocating blade. The cutting assembly is disposed exterior of the airway in proximity to the housing inlet such that hair clippings produced upon operation of the cutting assembly are drawn through the housing inlet into the airway for flow toward the vacuum source. Additionally, the apparatus includes a single motor disposed within the housing and operatively coupled to both the reciprocating blade and the vacuum source. The operative coupling to the vacuum source includes a drive gear operatively connected to the motor and having a first diameter, and a driven gear operatively connected to the vacuum source and having a second diameter less than the first diameter of the drive gear. The driven gear is directly coupled to the drive gear.

### BRIEF DESCRIPTION

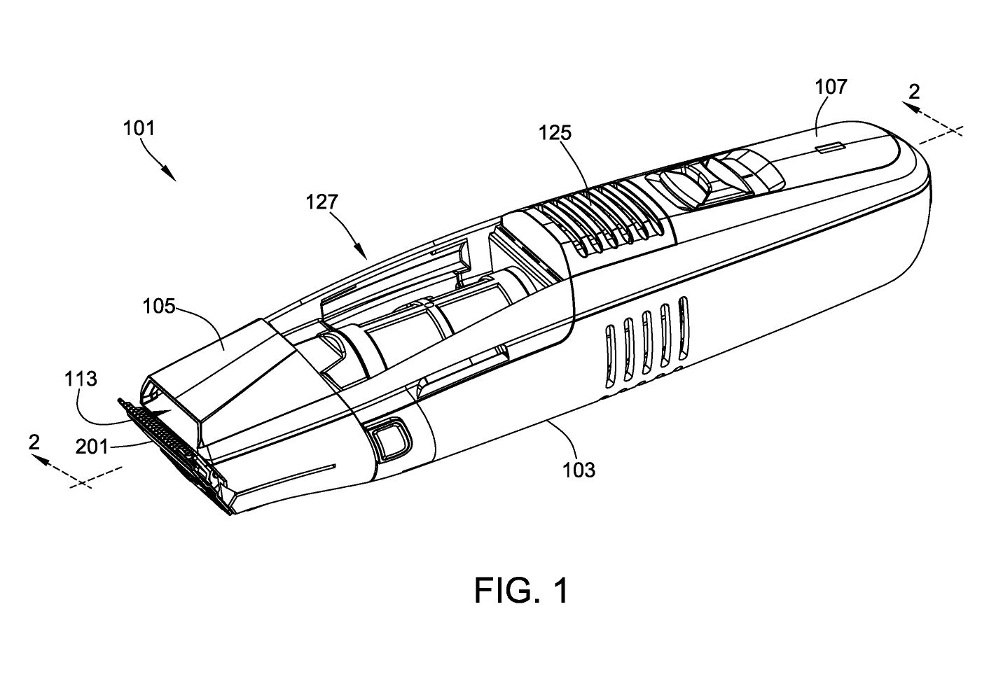

FIG. 1 is a perspective view of one embodiment of an electric hair trimmer;

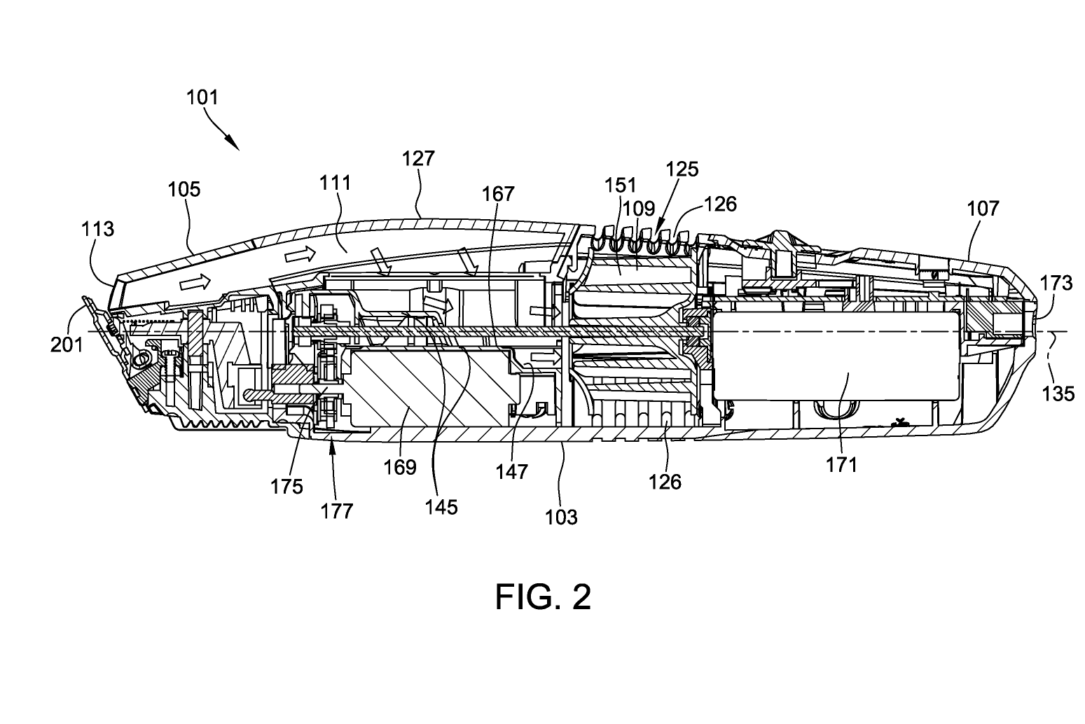

FIG. 2 is a cross-sectional view of the trimmer of FIG. 1;

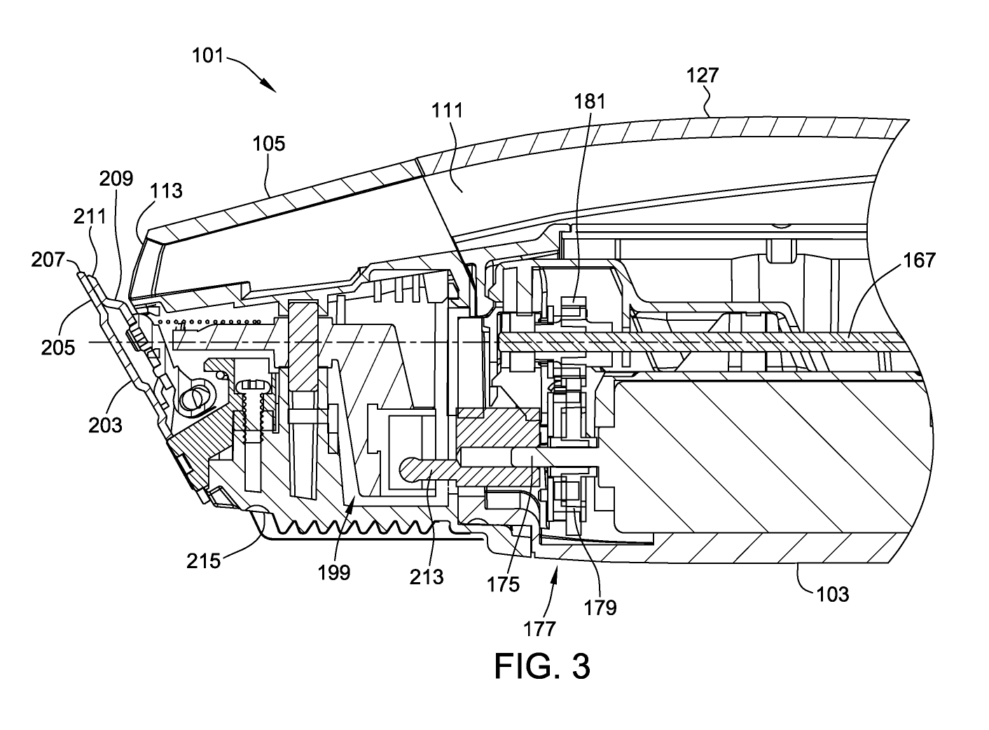

FIG. 3 is an enlargement of a portion of the cross-sectional view shown in FIG. 2;

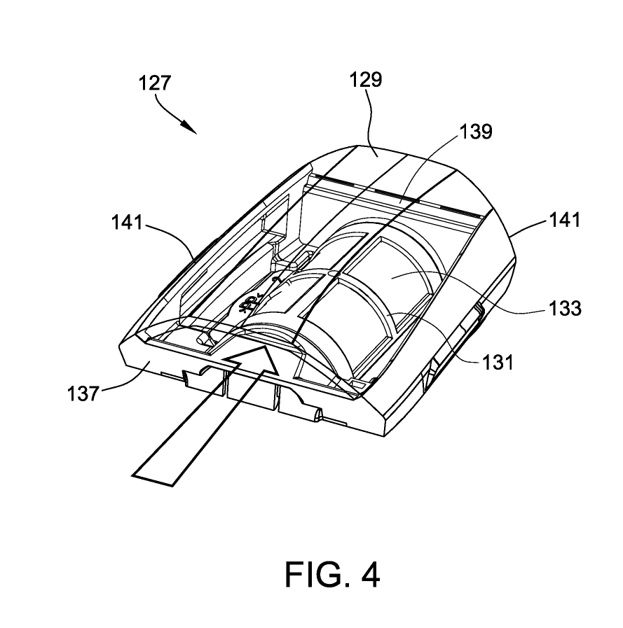

FIG. 4 is a perspective view of a collector bin of the trimmer of FIG. 1; and

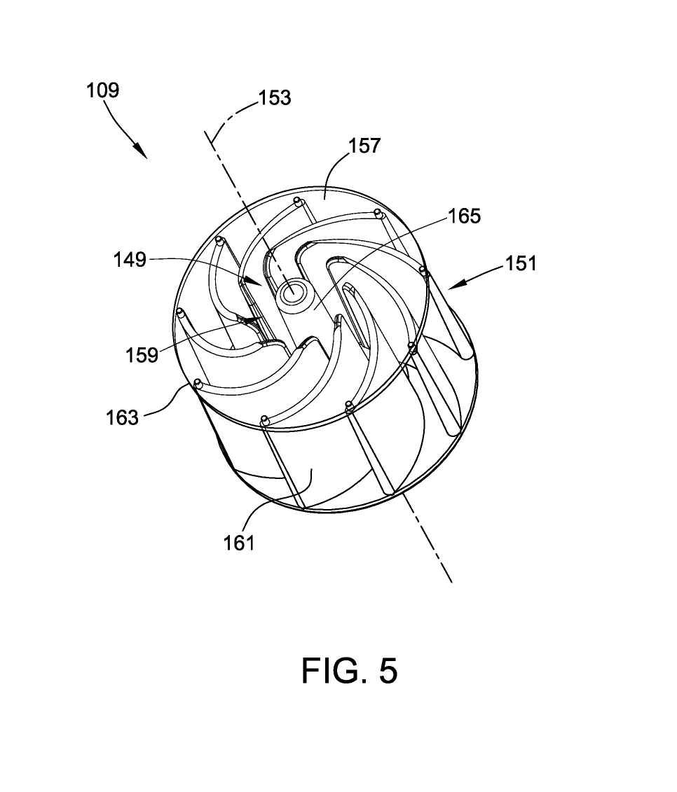

FIG. 5 is a perspective view of a vacuum fan of the trimmer of FIG. 1.

Corresponding reference characters indicate corresponding parts throughout the several views of the drawings.

### DETAILED DESCRIPTION

Referring now to the drawings and in particular to FIGS. 1, 2 and 3, a hand-held apparatus for trimming hairs according to one embodiment of the present disclosure is generally designated 101. The hair trimming apparatus 101 generally comprises a housing 103 having an upstream end 105 and a downstream end 107 (the terms upstream and downstream referring to the general direction in which air flows through the housing 103 as will be described), a vacuum source 109 disposed in the housing intermediate the upstream end and the downstream end thereof, and a trimmer assembly 201 (broadly, a cutting assembly) extending at least in part outward beyond the upstream end of the housing for trimming hair to produce hair clippings.

The housing 103 has an interior airway 111 extending from a housing inlet 113 disposed generally at the upstream end 105 of the housing to an exhaust 125 generally intermediate the upstream end and the downstream end 107 of the housing. In other embodiments, the exhaust 125 may be disposed nearer to the downstream end 107 of the housing 103 than as illustrated in FIG. 1 and remain within the scope of this disclosure. The housing 103 is suitably sized and shaped for being held in one hand. A collection bin 127 is releasably secured to the housing 103 in flow communication with the housing inlet 113 to, in part, define the interior airway 111 upstream of the vacuum source 109. The collection bin 127 facilitates the capture of hair clippings from the interior airway 111 before they reach the vacuum source 109.

One suitable embodiment of the collection bin 127 is illustrated in FIG. 4. The collection bin 127 includes an open end 137 to permit the entry of air and hair clippings into the collection bin 127 from the housing inlet 113 via the interior airway 111. A closed end 139 is opposite the open end 137, and opposing side walls 141 extend between the closed end 139 and the open end 137. An outer surface 129 extends between the opposing sidewalls 141. In the illustrated embodiment, the outer surface 129 is configured to create a smooth contour with the housing 103 when the collection bin 127 is secured to the housing. The outer surface 129 may be constructed of a translucent or transparent material so that a user can monitor the flow and collection of hair clippings in the collection bin 127.

A support web 131 opposite the outer surface 129 is configured to hold in place a screen 133, and to prevent air flow through the collection bin 127 other than through the screen 133. The screen 133 may be an essentially flat mesh member bent into an approximately semi-tubular profile, with a mesh aperture size configured to capture hair clippings from the air flow through the interior airway 111 while permitting airflow therethrough. Thus, the outer surface 129, the support web 131, the closed end 139, and the opposing sidewalls 141 define part of the interior airway 111, which enters the collection bin 127 at the open end 137 and exits the collection bin 127 through the screen 133. The screen 133 is elongated in a direction that is, in part, along the flow direction of air through the airway 111 to facilitate reducing interference with the air flow in the interior airway 111 by the captured hair clippings, thus avoiding an undesirable loss of vacuum strength.

The collection bin 127 is releasable from the housing 103 to facilitate emptying accumulated hair clippings from the collection bin 127. It is understood that any suitable releasable fastening techniques may be used to releasably secure the collection bin 127 to the base 103 without departing from the scope of this invention. In alternative embodiments, one or more of the support web 131, the screen 133, the closed end 139, and the opposing sidewalls 141 may be formed unitarily with, or non-releasably coupled to, the housing 103, and the outer surface 129 may comprise a releasable access panel to permit emptying of hair clippings from the collection bin 127 while it remains secured to the housing 103.

With reference now to FIGS. 1 and 5, the vacuum source 109 according to one embodiment comprises a centrifugal fan 151 mounted in the interior airway 111. It is understood, however, that in other embodiments the vacuum source 109 may comprise other suitable fans, such as without limitation an axial-flow fan, without departing from the scope of the invention. The vacuum source 109 may also be other than a fan unit, such as an air pump (e.g., a diaphragm Pump).

The fan 151 is rotatable about a rotation axis 153 oriented generally in the direction of air flow along the interior airway 111 from the housing inlet 113 to the exhaust 125. A cover plate 157 is coupled to an upstream end of the fan 151, and an aperture 159 defined in the cover plate 157 defines a fan inlet 149, which is generally circular and generally centered around the rotational axis 153 in the illustrated embodiment. The centered location of the fan inlet 149 with respect to the axis of rotation 153 improves an efficiency of work done on the air by the fan 151 for a given fan rotational speed, and therefore improves a vacuum strength created by the fan 151 for a given fan rotational speed.

The fan 151 comprises a plurality of arcuate vanes 161 extending generally radially outward from the rotation axis 153. In the embodiment of FIG. 5, the fan 151 comprises nine such vanes 161. In alternative embodiments, any suitable number of vanes 161 may be used. Each vane 161 sweeps radially outward from generally near the edge of aperture 159 toward a peripheral edge 163. A central spindle 165 is configured to be rotationally coupled to a fan drive shaft 167 (FIG. 2) to drive rotation of the fan 151. The vanes 161 are suitably configured such that rotation of the fan 151 about its rotation axis 153 draws air into the housing inlet 113 and downstream along the interior airway 111 to the fan 151.

With reference again to FIG. 2, the fan drive shaft 167, and hence the axis of rotation 153 of the fan, is approximately coaxial with a centerline 135 of the base housing 103 in the illustrated embodiment. This placement facilitates the largest possible size of the fan vanes 161 for a given size of the base housing 107, and larger fan vanes in turn facilitate increasing the vacuum strength of the fan.

A shaft cover 145 and a motor bracket 147 in the interior of housing 103 define a portion of the interior airway 111 upstream of the vacuum source 109, more particularly between the collection bin 127 and the vacuum source 109. The air flow passing through the screen 133 has velocity components normal to the air flow direction along the interior airway 111, and in some embodiments the section of the interior airway 111 immediately upstream of the vacuum source 109 is configured to redirect those normal components of the air flow toward the exhaust 125.

As shown in FIG. 2, the fan 151 of the illustrated embodiment is suitably located adjacent the exhaust 125. However, the exhaust 125 may be spaced farther downstream from the fan 151 without departing from the scope of this invention. In the illustrated embodiment, a plurality of exhaust openings 126 are formed in the housing 103 around at least a circumferential segment thereof to define the exhaust 125.

The vacuum source 109 is operably driven by an electric motor 169 disposed within the housing 103. As shown in FIG. 2, the location of the motor 169 may be offset from a generally longitudinal centerline 135 of the trimmer 101 to facilitate the location of the fan drive shaft 167 on or near the centerline 135. This placement also facilitates the location of the fan inlet 149, and of a section of the interior airway 111 immediately upstream of the fan inlet 149, proximate the centerline 135, which facilitates an increased efficiency of a vacuum source such as the fan 151, as discussed above.

The motor 169 may suitably be powered by a rechargeable battery 171, or alternatively by a hybrid battery/capacitor, or the like, disposed within the housing 103 and chargeable via a cord socket 173 disposed near the downstream end 107 of the trimmer 101. In other embodiments, the motor 169 may be powered by conventional batteries or directly by an external power source, such as a power cord surrounded in part by a suitable boot at the downstream end 107 of the trimmer 101. The motor 169 is tuned to operate at a suitable rate for driving the trimmer assembly 201. For example, the motor may be operable in the range of about 5,000 rpm to about 10,000 rpm, and in a particularly suitable embodiment about 7,000 rpm.

The motor 169 rotates a motor output shaft 175 at a first rotational speed equal to the operating speed of the motor. In some embodiments, a transmission system 177 is used to rotate the fan drive shaft 167 at a second rotational speed that is greater than the first rotational speed. In certain embodiments, the offset location of the motor 169 relative to the centerline 135 of the trimmer 101, as discussed above, also facilitates locating the fan drive shaft 167 parallel to, but transversely offset from, the motor output shaft 175. This in turn permits the transmission system 177 to drive the fan drive shaft 167 at a second, greater rotational speed than the motor operating speed using fewer transmission elements than otherwise would be needed.

With particular reference now to FIG. 3, in one embodiment the transmission system 177 includes a drive gear 179 rotationally coupled to the motor output shaft 175 for conjoint rotation therewith and having a first or drive gear diameter. The transmission system 177 further includes a driven gear 181 in operative connection with the drive gear 179. The driven gear 181 is mounted on the fan drive shaft 167 for conjoint rotation therewith, such that rotation of the driven gear drives rotation of the fan 151 of the vacuum source 109. In the illustrated embodiment, the driven gear 181 has a second or driven gear diameter that is less than the first or driving gear diameter of the drive gear 179. As a result, upon operation of the motor 169 at its operating speed, thus rotating the drive gear 179 at a rotational speed equal to the motor operating speed, the fan 151 is caused (via driven rotation of the driven gear 181 and fan drive shaft 167) to rotate at a second rotational speed that is greater than the first rotational speed of the drive gear.

For example, in one embodiment the driven gear 181 diameter to drive gear 179 diameter defines a gear ratio in the range of about 1:1.2 to about 1:2.5, and more suitably in the range of about 1:1.2 to about 1:2.0, and in the illustrated embodiment the gear ratio is about 1:1.65. As a result the rotational speed of the illustrated fan 151 is approximately 12,000 rpm upon operation of the motor at a speed of 7,000 rpm. The housing inlet 113 has an area of about 0.1872 square inches, resulting in an air velocity at the housing inlet 113 of about 1,753 feet per minute and a vacuum strength of about 0.2113 air watts. It is understood that the gear ratio of the driven gear 181 to drive gear 179 may be other than the above range, and that the rotational speed of the fan relative to the operating speed of the motor may be other than as set forth above without departing from the scope of this invention. The use of relatively few (e.g., only two) transmission gears 179, 181 to increase the rotational speed of the fan 151 relative to the motor facilitates a reduction in noise generated by the system 177, as well as increases operating efficiency thereof.

In an alternative embodiment, the motor output shaft 175 may extend from the motor 169 not only toward the trimmer assembly 201, as illustrated in FIG. 3, but also from an opposite end of the motor toward the vacuum source 109, and the driving gear 179 may be disposed on that opposite extension (not shown) of the motor output shaft 175. In such an embodiment, the driven gear 181 would be located correspondingly closer to the vacuum source 109 on the fan drive shaft 167 to cooperate with the drive gear 179, and the fan drive shaft 167 would be correspondingly shorter.

In other alternative embodiments, the transmission system 177 may comprise other elements that suitably produce the differing rotational rates, such as, but not limited to, a first pulley wheel (not shown) having a first diameter coupled to the motor output shaft 175, drivingly coupled by a belt to a second pulley wheel (not shown) having a second diameter coupled to the fan drive shaft 167, wherein the second diameter is less than the first diameter, causing the fan 151 to rotate at a second rotational speed that is greater than the first rotational speed of the drive gear 179.

With reference back to FIGS. 1, 2 and 3, the cutting assembly 201 comprises a mounting plate 203, a fixed or stationary cutting blade 205 secured to or integral with (as in the illustrated embodiment) the mounting plate and having cutting teeth 207 extending outward beyond the mounting plate, and a reciprocating cutting blade 209 held in slidable contact with the stationary cutting blade. In particular, the reciprocating cutting blade 209 has cutting teeth 211 held in sliding contact with the cutting teeth 207 of the stationary cutting blade 205 by a suitable spring assembly (not shown) disposed in the housing 103.

The reciprocating blade 209 is operatively connected to the electric motor 169 by a conventional drive assembly 199 having a recessed undercarriage 215. An eccentric pin 213 is mounted on or otherwise directly connected to the motor output shaft 175 for rotation thereof and sits within the recessed undercarriage to operatively connect the reciprocating blade 209 to the motor output shaft 175. Rotation of the eccentric pin 213 by the motor output shaft 175 drives the undercarriage 215 and hence the reciprocating blade 209 in reciprocating translation at a speed that corresponds directly with the rotational speed of the motor output shaft 175 (and hence the first or drive gear 179). Alternative embodiments may use other suitable structure for the drive assembly 199. Construction and operation of the trimmer assembly 201 and its operable connection to the motor 169 are known in the art and will not be described further herein except to the extent necessary to disclose the present invention.

Thus, it can be seen that a single motor 169 is used to drive both the trimmer assembly 201 and the vacuum source 109, while operating the vacuum source 109 at a higher speed than the trimmer assembly. The differing rates of operation of the vacuum source 109 and the trimmer assembly 201 facilitate a more desired operation of the trimmer assembly 201 while still providing an increased vacuum strength to capture hair clippings. The offset location of the motor 169 relative to the centerline 135 of the trimmer 101 allows the transmission system 177 to produce the different rotational speeds using relatively few transmission elements, facilitating a reduction in noise and an increase in the operating efficiency of the transmission system 177.

In the illustrated embodiment the single motor 169 directly drives the trimmer assembly 201 while the transmission system 177 is configured to “gear up” the operating speed of the vacuum source 109. It is understood, however, that in other embodiments the single motor may directly drive the vacuum source 109 at a desired high speed while the transmission system 177 is configured to “gear down” the operating speed of the trimmer assembly 201 so that the trimmer assembly operates at a speed less than that of the vacuum source.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. An electric hand-held apparatus for trimming hair, said apparatus comprising:
a housing having an upstream end, a downstream end, an inlet at said upstream end for receiving air and hair clippings into said housing, an exhaust downstream of the inlet for exhausting air from said housing, and an airway extending within said housing from said inlet to said exhaust for directing air flow through said housing;
a vacuum source disposed in said airway intermediate said inlet and said exhaust;
a cutting assembly comprising at least one reciprocating blade; and
a motor disposed within said housing, said motor comprising a motor output shaft rotatable about a motor axis, the motor axis being parallel to and transversely offset from an axis of rotation of said vacuum source, said at least one reciprocating blade being operatively connected to said motor output shaft for driving movement of said at least one reciprocating blade by said motor at a first speed, said vacuum source being operatively connected to said motor output shaft for driving movement of said vacuum source by said motor at a second speed greater than the first speed at which said at least one reciprocating blade is driven.

2. The apparatus set forth in claim 1 wherein said vacuum source is rotatable about the vacuum-source axis of rotation to draw air into the housing through said inlet and along said airway for subsequent exhaustion from the housing through said exhaust.

3. The apparatus set forth in claim 2 wherein said cutting assembly is disposed exterior of said airway in proximity to said housing inlet such that hair clippings produced upon operation of said cutting assembly are drawn through said housing inlet into said airway for flow toward said vacuum source.

4. The apparatus set forth in claim 3 wherein said motor output shaft is rotatable at a motor speed of operation, said at least one reciprocating blade being operatively connected to said motor output shaft for movement at a first speed of operation that corresponds directly to the motor speed of operation, said vacuum source being operatively connected to said motor output shaft for rotation at a second speed of operation that is greater than the motor speed of operation.

5. The apparatus set forth in claim 4 wherein said vacuum source is operatively connected to said motor output shaft by a transmission system configured for driving rotation of said vacuum source at a rotational speed greater than the motor speed of operation.

6. The apparatus set forth in claim 3 wherein said transmission system comprises a gear assembly.

7. The apparatus set forth in claim 6 wherein the gear assembly comprises a drive gear rotatably coupled to said motor output shaft and a driven gear drivingly connected to the drive gear.

8. The apparatus set forth in claim 7 wherein the vacuum source comprises a fan drive shaft and a vacuum fan rotatably coupled to the fan drive shaft, said driven gear being rotatably coupled to the fan drive shaft for conjoint rotation.

9. The apparatus set forth in claim 4 further comprising an eccentric drive operatively connected to the motor output shaft for conjoint rotation therewith upon operation of the motor, the reciprocating blade being operatively connected to the eccentric drive for driven reciprocating movement in response to operation of the motor.

10. An electric hand-held apparatus for trimming hair, said apparatus comprising:
a housing having an upstream end, a downstream end, an inlet at said upstream end for receiving air and hair clippings into said housing, an exhaust downstream of the inlet for exhausting air from said housing, and an airway extending within said housing from said inlet to said exhaust for directing air flow through said housing;
a vacuum fan disposed in said airway intermediate said inlet and said exhaust, said vacuum fan being operable to draw air into the housing through said inlet and along said airway for subsequent exhaustion from the housing through said exhaust, said vacuum fan having an inlet generally centered on an axis of rotation of said vacuum fan, wherein a portion of said airway upstream of said vacuum fan is configured to facilitate the flow of air into the vacuum fan inlet in a flow direction substantially parallel to the fan axis of rotation;
a cutting assembly comprising at least one reciprocating blade, said cutting assembly disposed exterior of said airway in proximity to said housing inlet such that hair clippings produced upon operation of said cutting assembly are drawn through said housing inlet into said airway for flow toward said vacuum source; and
a motor disposed within said housing, said motor comprising a motor output shaft rotatable about a motor axis, the motor axis being parallel to and transversely offset from the fan axis of rotation, said at least one reciprocating blade being operatively connected to said motor output shaft for driving movement of said at least one reciprocating blade by said motor at a first speed, said vacuum fan being operatively connected to the motor output shaft for driving rotation of the vacuum fan by the motor at a second speed greater than the first speed at which the at least one reciprocating blade is driven.

11. The apparatus set forth in claim 10 further comprising a fan drive shaft, wherein the vacuum fan is rotatably coupled to the fan drive shaft, the fan axis of rotation being coaxial with the fan drive shaft.

12. The apparatus set forth in claim 11 wherein the motor output shaft is rotatable at a motor speed of operation, the at least one reciprocating blade being operatively connected to the motor output shaft for movement at a first speed of operation that corresponds directly to the motor speed of operation, the fan drive shaft being operatively connected to the motor output shaft for rotation at a second speed of operation that is greater than the motor speed of operation.

13. The apparatus set forth in claim 12 wherein the fan drive shaft is operatively connected to the motor output shaft by a transmission system configured for driving rotation of the fan drive shaft at a rotational speed greater than the motor speed of operation.

14. The apparatus set forth in claim 13 wherein the transmission system comprises a gear assembly.

15. The apparatus set forth in claim 13 wherein the gear assembly comprises a drive gear rotatably coupled to the motor output shaft and a driven gear drivingly connected to the drive gear.

16. The apparatus set forth in claim 11 wherein the housing has a longitudinal centerline, the fan drive shaft being disposed one of on and adjacent the longitudinal centerline of the housing.

17. The apparatus set forth in claim 16 wherein the motor output shaft is offset transversely from the longitudinal centerline of the housing.

18. An electric hand-held apparatus for trimming hair, said apparatus comprising:
a housing having an upstream end, a downstream end, an inlet at said upstream end for receiving air and hair clippings into said housing, an exhaust downstream of the inlet for exhausting air from said housing, and an airway extending within said housing from said inlet to said exhaust for directing air flow through said housing;
a vacuum source disposed in said airway intermediate said inlet and said exhaust, said vacuum source being rotatable about an axis of rotation of said vacuum source to draw air into the housing through said inlet and along said airway for subsequent exhaustion from the housing through said exhaust;
a cutting assembly comprising at least one reciprocating blade, said cutting assembly disposed exterior of said airway in proximity to said housing inlet such that hair clippings produced upon operation of said cutting assembly are drawn through said housing inlet into said airway for flow toward said vacuum source; and
a single motor disposed within said housing and operatively coupled to both the reciprocating blade and the vacuum source, operative coupling to the vacuum source comprising a drive gear operatively connected to the motor and having a first diameter, and a driven gear operatively connected to the vacuum source and having a second diameter less than the first diameter of the drive gear, the driven gear being directly coupled to the drive gear.

19. The apparatus set forth in claim 18 wherein a gear ratio defined as a ratio of the second diameter of the driven gear to the first diameter of the drive gear is in the range of about 1:1.2 to about 1:2.5.

20. The apparatus set forth in claim 18 wherein the reciprocating blade is operatively connected directly to the motor for operation at speed equal to the operating speed of the motor.
